(19) United States
(12) Patent Application Publication
(10) Pub. No.: US 2009/0064098 A1
(43) Pub. Date: Mar. 5, 2009

(54) METHOD AND SYSTEM FOR SCENARIO-BASED VISUALIZATION

(76) Inventors: Jinchao Huang, Markham (CA); Michael Starkey, Vancouver (CA)

Correspondence Address: HOFFMAN WARNICK LLC, 75 STATE ST, 14TH FLOOR, ALBANY, NY, 12207, US

(21) Appl. No.: 11/845,911

(22) Filed: Aug. 28, 2007

(51) Int. Cl. G06F 9/45

(52) U.S. Cl. 717/109

(57) ABSTRACT

The invention provides a method and system for generating a visual representation of an interaction between a computer system and a user.

### TECHNICAL FIELD

The invention relates generally to visualization techniques and, more particularly, to a method and system for generating a visual representation of an interaction between a computer system and a user.

### BACKGROUND OF THE INVENTION

Software development often requires the visualization of user requirements based on particular business scenarios or user-system interaction requirements. Such visualizations are helpful in demonstrating the capabilities of a piece of software, enabling software developers, marketing specialists, business analysts, and/or potential users to properly assess user requirements before the software development process is complete.

Typically, such visualizations are created by hand based on the functional specifications of the software and/or user requirements. However, hand-created visualizations are labor intensive to prepare. In addition, making changes to the software functionality and/or user requirements often result in poor traceability or recreation of the hand-created visualizations.

Accordingly, there exists a need in the art to overcome the deficiencies and limitations described hereinabove.

### SUMMARY OF THE INVENTION

The invention provides a method and system for generating a visual representation of an interaction between a computer system and a user.

A first aspect of the invention provides a method of generating a visual representation of an interaction between a computer system and a user, the method comprising: accessing a user scenario comprising: at least one user role; at least one business object; at least one user task; and at least one computer system role; constructing a data view for each business object and an action view for each user task; selecting at least one user-system interaction pattern from a database of pre-defined user-system interaction patterns based on the at least one user role; and generating a visual representation of the user scenario using the data view(s), action view(s), and user-system interaction pattern.

A second aspect of the invention provides a system for generating a visual representation of an interaction between a computer system and a user, the system comprising: a system for accessing a user scenario comprising: at least one user role; at least one business object; at least one user task; and at least one computer system role; a system for constructing a data view for each business object and an action view for each user task; a system for selecting a user-system interaction pattern from a database of pre-defined user-system interaction patterns based on the at least one user role; and a system for generating a visual representation of the user scenario using the data view(s), action view(s), and user-system interaction pattern.

A third aspect of the invention provides a program product stored on a computer-readable medium, which when executed, accesses a user scenario comprising: at least one user role; at least one business object; at least one user task; and at least one computer system role; constructs a data view for each business object and an action view for each user task; selects a user-system interaction pattern from a database of pre-defined user-system interaction patterns based on the at least one user role; and generates a visual representation of the user scenario using the data view(s), action view(s), and user-system interaction pattern.

The illustrative aspects of the present invention are designed to solve the problems herein described and other problems not discussed, which are discoverable by a skilled artisan.

### BRIEF DESCRIPTION OF THE DRAWINGS

These and other features of this invention will be more readily understood from the following detailed description of the various aspects of the invention taken in conjunction with the accompanying drawings that depict various embodiments of the invention, in which:

FIG. 1 shows a unified modeling language (UML) activity diagram depicting an illustrative user scenario.

FIG. 2 shows a flow diagram of an illustrative method according to the invention.

FIG. 3 shows illustrative visualizations of a user scenario generated according to the invention.

It is noted that the drawings of the invention are not to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

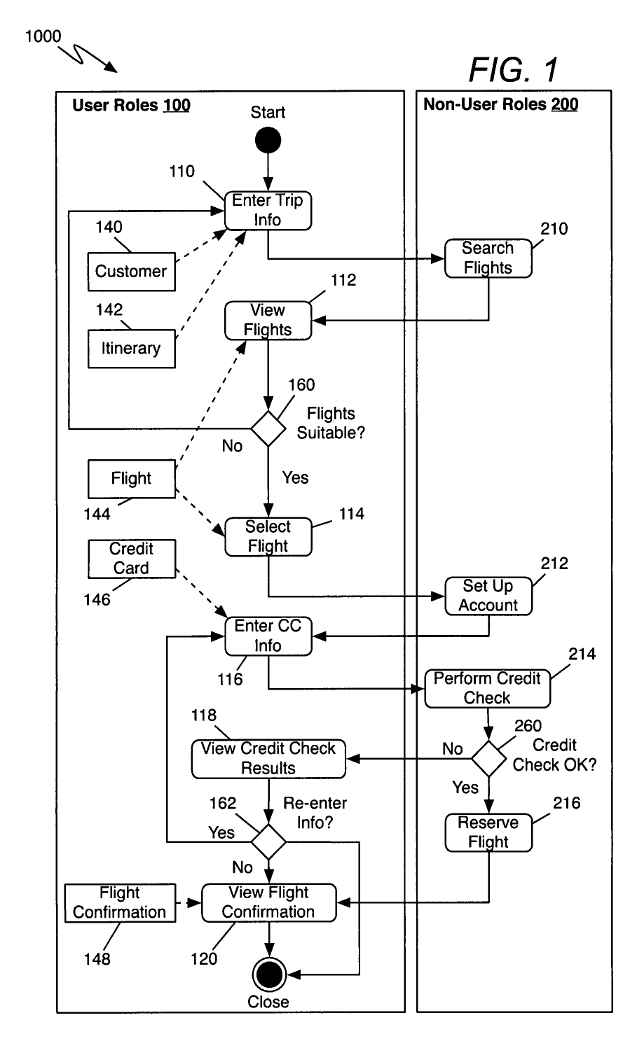

FIG. 1 shows a unified modeling language (UML) activity diagram 1000 depicting a user scenario that could be subjected to visualization according to the invention. The user scenario shown in FIG. 1 involves the selection of flights using a computer system, although any number of scenarios may be visualized according to the invention, the scenario shown in FIG. 1 being merely for illustrative purposes.

As shown in FIG. 1, activity diagram 1000 is divided into user roles 100 and non-user roles 200. Within user roles 100 may be found user tasks 110-120, 160, 162, which include decisions a user must make and/or actions a user must take in executing the user scenario. Also show are business objects 140-148, which include data, objects, or other information that a user may perceive, manipulate, or otherwise use in executing a user task 110-120. Non-user roles 200 include decisions 260 or tasks 210-216 made or executed by a computer system with which the user is interacting and/or a third party (including computer systems with which the user is not directly interacting).

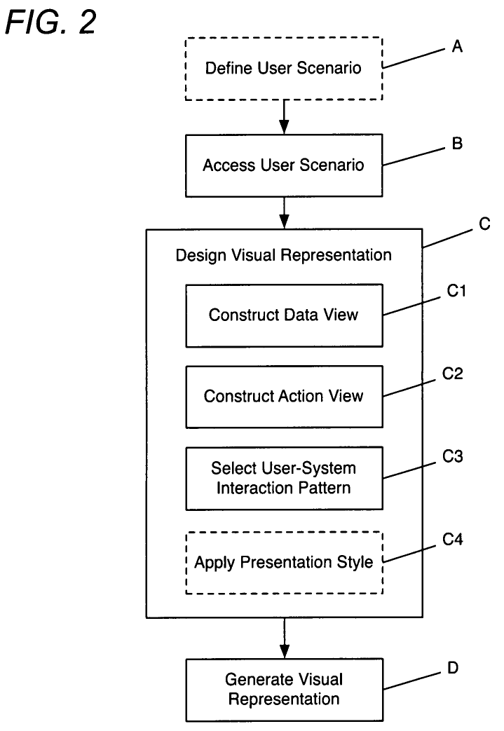

FIG. 2 shows a block and flow diagram of an illustrative method according to an embodiment of the invention. At A, a user may optionally define a user scenario. Alternatively, a user may select a user scenario from a pre-defined collection of user scenarios, such as may be found in a computer database. In either case, the user scenario is accessed at B.

At C, a visual representation of the user scenario is designed. This may include constructing a data view for each business object at C1, constructing an action view for each user task at C2, and selecting a user-system interaction pattern based on a user's role at C3. The user's role in the user scenario of FIG. 1, for example, may be that of an online purchaser. The user-system interaction pattern selected at C3, therefore, would be based on the user's role as an online purchaser. The user-system interaction pattern may include activities, tasks, and/or options based on the user's role, such as the inclusion of a secure login page or a secure page for entering credit card information. Designing the visual representation may optionally further include applying a presentation style at C4, wherein the presentation style controls the overall appearance of the visualization being designed (e.g., color scheme, font choice, etc.).

At D, the visual representation designed at C is generated. Once generated, the visual representation may be presented to a user and, optionally, stored or otherwise indexed for future reference. For example, in the event that the same user accesses the same or a similar user scenario at a later time, some or all of the visual representation generated at D may be retrieved from storage and/or used as a pre-defined template for the generation of a new visual representation.

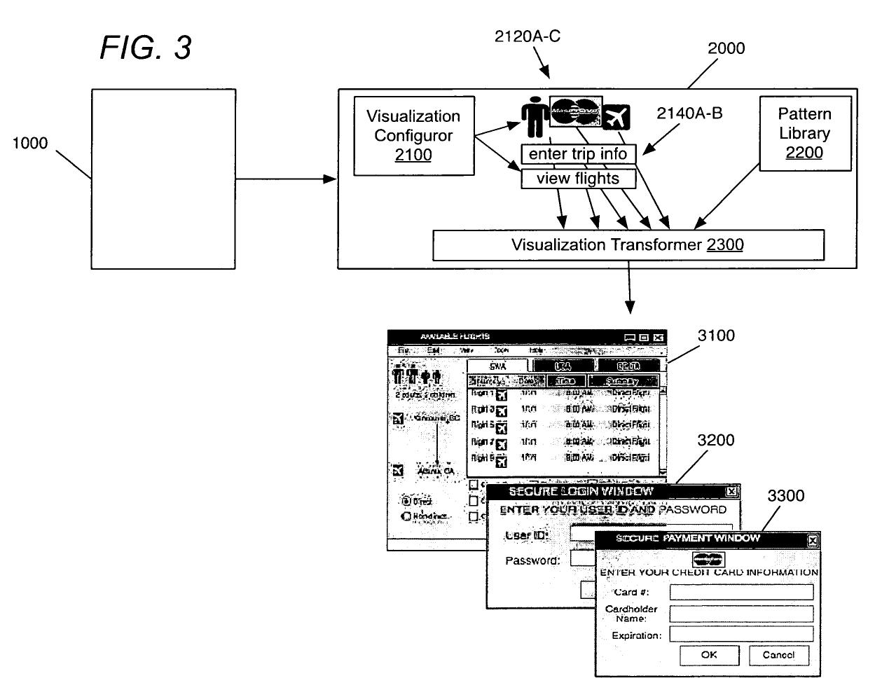

FIG. 3 shows a graphical view of the generation of a plurality of visual representations according to one embodiment of the invention. The user scenario shown in activity diagram 1000 (FIG. 1) is accessed by a visualization engine 2000. Visualization engine 2000 comprises a visualization configuror 2100 for constructing data views 2120A-C for business objects and action views 2140A-B for user tasks, a pattern library 2200 containing pre-defined user-system interaction patterns and presentation styles, and a visualization transformer 2300 for rendering visualizations 3100, 3200, 3300 of the user scenario. For example, visualization 3100 may be generated to enable a user to complete user task 112 (FIG. 1), visualization 3200 to enable a user to securely log onto a website, and visualization 3300 to enable the completion of user task 116 (FIG. 1).

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

What is claimed is:

1. A method of generating a visual representation of an interaction between a computer system and a user, the method comprising:
accessing a user scenario comprising:
at least one user role;
at least one business object;
at least one user task; and
at least one computer system role;
constructing a data view for each business object and an action view for each user task;
selecting at least one user-system interaction pattern from a database of pre-defined user-system interaction patterns based on the at least one user role; and
generating a visual representation of the user scenario using the data view(s), action view(s), and user-system interaction pattern.

2. The method of claim 1, further comprising:
defining the user scenario.

3. The method of claim 1, further comprising:
selecting a presentation style from a database; and
applying the presentation style to at least one of the following: the data view(s), the action view(s), and the user-system interaction pattern.

4. A system for generating a visual representation of an interaction between a computer system and a user, the system comprising:
a system for accessing a user scenario comprising:
at least one user role;
at least one business object;
at least one user task; and
at least one computer system role;
a system for constructing a data view for each business object and an action view for each user task;
a system for selecting at least one user-system interaction pattern from a database of pre-defined user-system interaction patterns based on the at least one user role; and
a system for generating a visual representation of the user scenario using the data view(s), action view(s), and user-system interaction pattern.

5. The system of claim 4, further comprising:
a system for defining the user scenario.

6. The system of claim 4, further comprising:
a system for selecting a presentation style from a database; and
a system for applying the presentation style to at least one of the following: the data view(s), the action view(s), and the user-system interaction pattern.
